(19) United States
(12) Patent Application Publication
(10) Pub. No.: US 2021/0216935 A1
(43) Pub. Date: Jul. 15, 2021

(54) DEVICE AND METHOD FOR PROVIDING EVENT/PERFORMANCE SUPPORT SERVICE

(71) Applicant: Jung Ryul LEE, Goyana-si, Gyeonggi-do (KR)

(72) Inventor: In Ok MOON, Goyang-si (KR)

(73) Assignee: Jung Ryul LEE, Goyana-si, Gyeonggi-do (KR)

(21) Appl. No.: 17/059,891

(22) PCT Filed: Jul. 26, 2019
(86) PCT No.: PCT/KR2019/009315

§ 371 Date: Nov. 30, 2020

(30) Foreign Application Priority Data
Aug. 17, 2018 (KR) 10-2018-0096245

(51) Int. Cl. G06Q 10/06; G06Q 10/02; G06Q 10/10

(52) U.S. Cl. CPC G06Q 10/06315; G06Q 10/103; G06Q 10/02

(57) ABSTRACT

The present invention relates to a device and a method for providing an event/performance support service by using a dedicated application for event/performance support loaded on a user terminal. Planning and carrying out an event/performance may be more easily done by means of the method for providing an event/performance support service, the method comprising the steps of: receiving, as an input, basic information on the nature and scale of an event/performance via a dedicated application for event/performance support loaded on a user terminal held by the organizer of the event/performance; on the basis of the inputted basic information, selecting event/performance support contractors for carrying out the event/performance, generating an event/performance support contractor recommendation list including information on the selected event/performance support contractors, and providing same via the dedicated application for event/performance support; having at least one event/performance support contractor, in the provided event/performance support contractor recommendation list, selected via the dedicated application for event/performance support; transferring, to the selected event/performance support contractor, information on the event/performance organizer and a request for liaising for the event/performance; and receiving, from the event/performance support contractor, a reply to the transferred request for liaising for the event/performance, and notifying whether the liaising is possible via the dedicated application for event/performance support.

### TECHNICAL FIELD

The present invention relates to a device and method for providing event/performance support service, and more particularly to a device and method, operating online, for providing information, required for planning and managing event/performances, such as information on event/performance support service vendors or artists as well as recommending event/performance models pre-planned in a form of package, whereby event/performance organizers make service requests for themselves.

### BACKGROUND

With the prior art, whenever event/performance organizers, such as local governments or businesses, desire to plan and hold event/performances, they have to commission the job to service vendors or directly contact management companies or agents of artists to make service requests.

However these organizers have limitations to their capacity and channels to plan and hold an event/performance whether it be a college festival, a birthday party, etc. by directly contacting such entertainers as MCs, comedians, singers, classical musicians, etc.

That is, especially when organizers are small organizations or individuals, they don't have an easy and usual access to channels to contact entertainers except for a few number of artists, so they have nothing but to make relevant service requests via regional agencies or agents.

In this situation, provincial event/performances have been almost monopolized by a few number of high-profile entertainers while contracts and transactions among organizers, agencies and artists have not been so transparent.

Thus organizers are often forced to do business, directly, with stage setting service providers with only a small number of options through personal connections due to limited and closed information available.

These realistic and systematic problems often lead to obscure or excessive service charges. These problems, in turn, increase the budget for event/performances while entertainers' fee may vary a lot depending on their personal relationship with event hosts.

On the other hand, there are artist agency websites currently operating, but these websites are limited in complementing agents' off-line efforts because even with these websites, once clients make service requests on-line, agents still have to contact individual artists in a conventional way, that is, off-line, to discuss service arrangements including fees based on the clients' requests.

And an event/performance may require many different types of artists, so there are obvious limitations when individual clients try to personally contact and secure different types talents or professionals such as those in pop, jazz, classical, and traditional fusion music, magic, art, and presentation, etc.

It is almost prohibitive for small sized organizations or individuals to plan events for themselves with such limited information available.

### DETAILED DESCRIPTION OF THE INVENTION

### Technical Problems to be Solved

The present disclosure is conceived to overcome the limitations discussed supra. A first objective of the present disclosure is to provide event/performance organizers who have been faced with difficulties due to limited information available when they desire to plan and hold an event/performance with a device and method for giving access to information on event/performance service vendors and artists as recommended via a homepage, mobile devices, and applications, etc.

A second objective of the present disclosure is to provide a device and method for proposing, to organizers who desire to hold an event/performance, event/performance models, which are packages predetermined with artists and stage settings relevant to scales (small, medium, or large) and types of event/performances, thereby reducing their time and efforts required.

And a third objective of the present disclosure is to provide an event/performance support service, with which, without any intermediaries like agencies between both parties of an event/performance (that is, the organizer and the artists), organizers can, peer to peer and via an application on their terminal, directly forward service requests to artists, and check their availabilities.

### Method for Solving the Problems

For the purpose of solving the problems discussed supra, the present disclosure comprises the features as follows.

According to an embodiment of the present disclosure, a method for providing event/performance support service comprises steps of: inputting, by an event/performance organizer with a dedicated application for event/performance support service installed on their terminal, basic information including scale and type of an event/performance; selecting event/performance service vendors based on the basic information so input, generating a list of recommended event/performance support service vendors including information on their service, and providing the same via the dedicated application; selecting, via the dedicated application, at least one from the list of recommended event/performance support service vendors; forwarding information on the event/performance organizer and their service requests to the event/performance support service vendors; receiving replies to the service requests from the event/performance support service vendors, and notifying the event/performance organizer of availabilities of the event/performance support service vendors.

On the other hand, according to an embodiment of the present disclosure, a device for providing event/performance support service comprises: a service request input module for inputting, by an event/performance organizer with a dedicated application for event/performance support service installed on their terminal, basic information including scale and type of an event/performance; a support service list module for selecting event/performance service vendors based on the basic information so input, generating a list of recommended event/performance support service vendors including information on their service, and providing the same via the dedicated application; a selection module for selecting, via the dedicated application, at least one from the list of recommended event/performance support service vendors; a service request forwarding module for forwarding information on the event/performance organizer and their service requests to the event/performance support service vendors; a notification module for receiving replies to the service requests from the event/performance support service vendors, and notifying the event/performance organizer of availabilities of the event/performance support service vendors.

### Effects of the Invention

The present disclosure may achieve the effect of providing event/performance organizers who have been faced with difficulties due to limited information available when they desire to plan and hold an event/performance with a device and method for giving access to information on event/performance service vendors and artists as recommended via a homepage, mobile devices, and applications, etc., thereby overcoming said difficulties.

And the present disclosure may also provide a device and method for proposing, to organizers who desire to hold an event/performance, event/performance models, which are packages predetermined with artists and stage settings relevant to scales (small, medium, or large) and type of event/performances, thereby reducing their time and efforts required.

And the present disclosure may further provide an event/performance support service, with which, without any intermediaries like agencies between both parties of an event/performance (that is, the organizer and the artists), organizers can, peer to peer and via an application on their terminal, directly forward service requests to artists, and check their availabilities.

In addition, with the help of the present disclosure, fully-fledged artists will have more jobs to offer their services; beginning artists right from their schools will have opportunities to introduce themselves to the market; and entrepreneurs will find potential to establish start-ups like an one-man agency for managing events and offering relevant services.

The effects of the present disclosure are not limited to the above-mentioned effects, and other effects not mentioned herein will be clearly understood by those skilled in the art from the following description.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a schematic diagram showing the actions of a device for providing event/performance support service according to an embodiment of the present disclosure;

FIG. 2 is a block diagram showing the configurations of a device for providing event/performance support service according to an embodiment of the present disclosure;

FIG. 3 is a flowchart showing the process of a method for providing event/performance support service according to an embodiment of the present disclosure;

FIG. 4 is an exemplary view illustrating a method for providing event/performance support service.

### BEST FORMS TO IMPLEMENT THE PRESENT DISCLOSURE

The technical terms used for describing the present disclosure are intended to illustrate certain embodiments, so they should not be understood as limiting the present disclosure. And unless specified otherwise, the technical terms used for describing the present disclosure should be understood as meanings which are commonly accepted by a person skilled in the art, but not as excessively broad or narrow meanings.

Hereinafter, exemplary embodiments of the present disclosure will be described in detail with reference to the accompanying drawings.

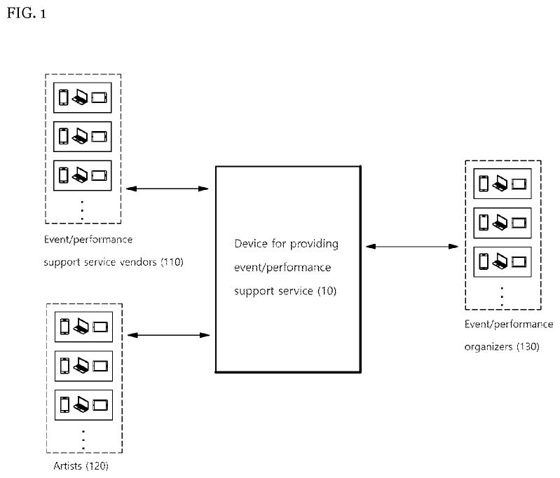

FIG. 1 is a schematic diagram showing the actions of a device for providing event/performance support service according to an embodiment of the present disclosure.

As shown in FIG. 1, a device for providing event/performance support service 10 obtains basic information on event/performances via a dedicated application for event/performance support service running as installed on terminals owned by a plurality of event/performance organizers 130.

Herein event/performances should be construed as all possible forms of events including small sized family events, friendly gatherings, corporate events, performances such as play and dance, exhibitions and local festivals, etc.

In an embodiment of the present disclosure, a plurality of event/performance organizers 130 should be understood as including any entities which plan and host event/performances.

For example, event/performance organizers may be central or local governments, hosting organizations of local festivals, public enterprises or conglomerates, SMEs, event agencies, individuals, or social groups such as fan clubs, etc.

And the device for providing event/performance support service 10 stores basic information on event/performance support service vendors 110 in a database.

In an embodiment of the present disclosure, event/performance support service vendors should be construed as all possible businesses which manage and carry out tasks required for holding event/performances including not only vendors providing at least one of the services in audio, lighting, video, or stage settings, but also stage arts service vendors, musical instruments rental companies, owners of exhibition spaces, shipping and delivering services for art works, a variety of marketing agencies, etc.

The device for providing event/performance support service 10 obtains and stores, based on membership, information including scale of stages, types of event/performances which can be handled by event/performance support service vendors, their schedules, and fees, etc.

In addition, the device for providing event/performance support service 10 also stores basic information on artists 120 in a database.

Artists herein should be construed as all kinds performers who are demanded for holding event/performances including, but not limited to, singers, instrument players, choreographers, MCs, magicians, opera singers, dancers, stage artists, photographers, famous entrepreneurs and celebrities, etc.

The device for providing event/performance support service 10 may select and recommend event/performance support service vendors and artists which may be needed by event/performance organizers 130.

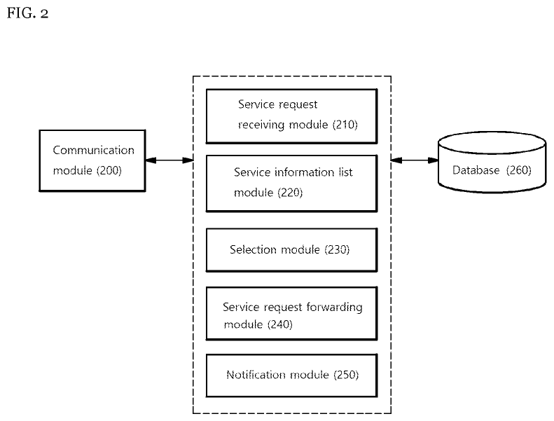

FIG. 2 is a block diagram showing the configurations of a device for providing event/performance support service according to an embodiment of the present disclosure.

As shown in FIG. 2, a device for providing event/performance support service comprises a communication module 200; a database 260; a service request receiving module 210; a service information list module 220, a selection module 230; a service request forwarding module 240; a notification module 250.

The communication module 200 should be construed as including any technical configurations for receiving and transmitting information via wired or wireless telecommunication systems. In an embodiment of the present disclosure, the communication module 200 carries out data communications to and from terminals owned by event/performance support service vendors, event/performance organizers, artists, and/or event/performance planners.

The database 260 stores information on event/performance support service vendors, artists, and event/performance models as packages predetermined by event/performance planners.

The database 260 may be implemented as big data. With the database 260 as linked to the service information list module 220, not only information on event/performance support service vendors, artists, and event/performance models can be managed, but also lists of recommended event/performance support services can be created based on more varied standards and methods.

The service request receiving module 210 receives basic information on type and scale of event/performances and event/performance support service requests via a dedicated application for event/performance support service installed on terminals owned by event/performance organizers.

The service information list module 220 selects, based on basic information on types and scale of event/performances received by the service request receiving module 210, event/performance support service vendors for at least one of the areas of venue, audio, lighting, video, stage settings.

Meanwhile, the database 260 collates a variety of key aspects from the information stored therein including types of event/performance support service vendors, their capabilities to handle event/performances, their availabilities, locations, and fees, etc., which are used for evaluating whether the vendors can handle event/performances considering their types and scale.

The service information list module 220 may select event/performance support service vendors suitable for type and scale of event/performances based on the information stored in the database 260.

The service information list module 220 generates a list of the recommended event/performance support service vendors so selected, and send the same to terminals owned by event/performance organizers. The event/performance organizers check the list of the recommended event/performance support service vendors via a dedicated application for event/performance support service installed on their terminals.

The selection module 230 selects at least one from the list of the recommended event/performance support service vendors provided via the dedicated application for event/performance support service installed on event/performance organizers' terminals.

The service request forwarding module 240 forwards service requests along with information on organizers, type and scale of event/performances to the event/performance support service vendors selected by the selection module 230.

The notification module 250 receives replies to the service requests forwarded by the service request forwarding module 240 from the event/performance support service vendors, and notifies the event/performance organizers of the availabilities of the vendors via a dedicated application installed on their terminals.

In an embodiment of the present disclosure, the service request receiving module 210 further receives requests for information on artists required for event/performances via a dedicated application for event/performance support service.

With that, the service information list module 220 generates a list of recommended artists who match the requests for artists received based on the information on profiles and availabilities of individual artists stored in the database 260.

A profile of an individual artist may be set and edited by the individual artist him/herself when signing up for membership and includes desired fees, career history and other particulars.

In an embodiment of the present disclosure, a device for providing event/performance support service comprises a function of artists' schedule. Artists may input information on their performance or appearance on broadcast, which, in turn, is stored and updated on artists' schedule by the database 260.

And when an artist accepts a request for event/performance service, his/her schedule will be updated accordingly. As artists' schedules are frequently updated, it is possible to generate a list of recommended artists only currently available for given event/performances.

That is, event/performance organizers input basic information comprising date/time, types (genre and area), and budget of event/performances to be held, based on which the service information list module 220 selects recommended artists.

And then the service information list module 220 generates a list of recommended artists based on information on event/performances including their types and budget, travel time and cost depending on the venue, etc.

The list of recommended artists so generated is provided to the event/performance organizers via the dedicated application for event/performance support service installed on their terminals.

The selection module 230 selects at least one from the list of the recommended artists provided via the dedicated application for event/performance support service installed and operating on the event/performance organizers' terminals.

In an embodiment of the present disclosure, the selection module 230 may recognize it as (provisional) contract when organizers select desired artists from the list of the recommended artists.

And it is also possible that once a down payment made by an event/performance organizer is confirmed, a contract is automatically executed and sent as a form of electronic document to both parties (organizer and artists) via email or mobile devices.

And it is also possible that with a reverse auction event/performance organizers may first put up estimates of budget for event/performances and then event/performance support service vendors place bids for best fulfilling the service requests.

The notification module 250 forwards service requests to the artists selected by the selection module 230, and, once replies to the service requests are received from the artists, notifies the organizer of the availabilities of the artists via the dedicated application for event/performance support service.

In addition, it is possible that the device for providing event/performance support service further comprises a cost estimate module, with which a cost estimate is automatically generated based on the information on the event/performance support service vendors and artists selected by event/performance organizers.

In another embodiment of the present disclosure, the service information list module 220 may apply at least one item of types, budget, and number of audience, etc. based on basic information input and then generate a list of recommended event/performance models as matching given conditions from those preplanned and stored as a form of package in the database 260.

Herein event/performance models mean plans covering overall process of event/performances as predetermined, in a form of package, with at least some of such necessities required for holding event/performances as stage setting, artists, lighting, audio, etc.

The event/performance models may be packages preplanned by event/performance support service vendors, or plans as produced and stored by artists for themselves.

The service information list module 220 recommends different event/performance models depending on type, budget, time and space, and the number of audience of event/performances.

With that, appropriate event/performance models can be recommended as packages preplanned with artists and stage settings suitable for the scale (small, medium, or large) of event/performance the event/performance organizer desires, thereby reducing time and efforts required.

And the lists of recommended event/performance models so generated are provided via a dedicated application for event/performance support service.

The selection module 230 selects at least one from the list of the recommended event/performance models provided via the dedicated application for event/performance support service installed and operating on event/performance organizers' terminals.

The notification module 250 forwards service requests to event/performance planners selected by the selection module 230, and, once replies to the service requests are received, notifies the organizers of the availabilities via the dedicated application for event/performance support service.

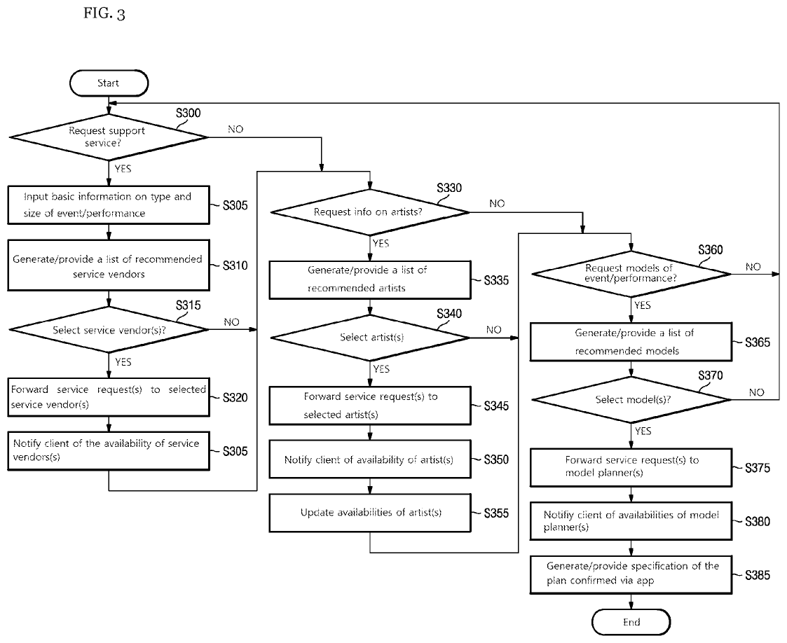

FIG. 3 is a flowchart showing the process of a method for providing event/performance support service according to an embodiment of the present disclosure.

First, basic information on types and scale of event/performances is input S305 via the dedicated application for event/performance support service installed on terminals owned by the event/performance organizer based on service requests received therein S305.

And event/performance support service vendors for at least one of venue, audio, lighting, video, or stage settings are selected based on basic information input. A list of the recommended event/performance support service vendors so selected is generated and then provided via the dedicated application for event/performance support service S310.

Herein selecting event/performance support service vendors may be carried out by matching the vendors with the type and scale of event/performances the organizer desires.

Event/performance organizers select at least one from the list of the recommended event/performance support service vendors via the dedicated application for event/performance support service installed on their own terminals S315, and then the relevant service requests are forwarded to the vendors so selected S320.

And once replies to the service requests are received from the event/performance support service vendors, their availabilities are notified to the event/performance organizers via the dedicated application for event/performance support service S325.

In a further embodiment of the present disclosure, the service request receiving module 210 further receives requests for information on artists required for event/performances via a dedicated application for event/performance support service S330.

Then a list of recommended artists is generated by matching information on profile and schedule of individual artists stored with service requests received, and then provided via the dedicated application for event/performance support service S335.

And then the event/performance organizers select at least one from the list of the recommended artists so provided via the dedicated application for event/performance support service S340.

And then service requests along with basic information on the event/performances are forwarded to the artists so selected S345, and, once replies to the service requests are received, the availabilities of the artists are notified S350.

Further, once replies to the service requests are received from the artists selected, the schedules of the artists are updated and stored accordingly.

Once the employments of the artists are approved, the schedules of the artists may be instantly updated, so only those artists currently available according to their schedules may be recommended. In this way, information on artists can be provided to event/performance organizers more correctly and quickly.

In another embodiment of the present disclosure, once requests for event/performance models as preplanned and stored in a form of package are received from event/performance organizers S360, appropriate event/performance models are selected by matching at least one of such items as type, budget, and number of audience of the event/performances based on the basic information of event/performances provided by the organizers with event/performance models preplanned and stored in a form of package.

Herein event/performance models mean plans covering overall process of event/performances as predetermined, in a form of package, with at least some of such necessities required for holding event/performances as stage setting, artists, lighting, audio, etc. The event/performance models may be packages preplanned by event/performance support service vendors, or plans as produced and stored by artists for themselves.

The service information list module 220 may recommend different event/performance models depending on type, budget, time and space, and the number of audience of event/performances.

With that, appropriate event/performance models may be recommended as preplanned and packaged with artists and stage settings suitable for the scale (small, medium, or large) of event/performance the organizer desires, thereby reducing time and efforts required.

And the lists of the recommended event/performance models so generated are provided via a dedicated application for event/performance support service S365.

And then the event/performance organizer selects at least one from the list of the recommended event/performance models via the dedicated application for event/performance support service S370.

And then service requests are forwarded to event/performance planners S375, and, once replies to the service requests are received, the availabilities are notified to the event/performance organizers S380.

And then the event/performance organizer further provides at least one of the specific options for the event/performance model so selected such as MCs, type of choreography, chorus, stage settings, and sound effect, etc.

In that way, it is possible that event/performance organizers may optionally select and change the details of the event/performance model so selected.

A specification of an event/performance including information on at least one of the event/performance support service vendors confirmed, summary of stage settings; cost estimate, names of the artists confirmed, planned contents of event/performances is generated and then provided via the dedicated application for event/performance support service S385.

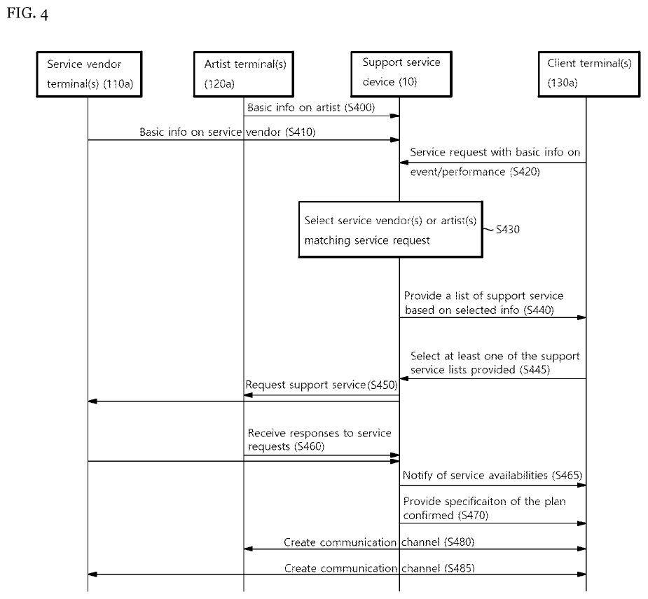

FIG. 4 is an exemplary view illustrating a method for providing event/performance support service.

First, a device for providing event/performance support service 10 stores personal information input by terminals of event/performance support service vendors 110a and terminals of artists 120a while signing up for membership.

And then basic information on event/performances and service requests are received S420 from event/performance organizers' terminals 130a. Herein the service requests for event/performances may be towards event/performance support service vendors or artists.

And then the device for providing event/performance support service 10 selects S430 event/performance support service vendors or artists matching the basic information on the event/performances input by the event/performance organizers' terminals 130a.

Based on information on event/performance support service vendors or artists so selected, a list of recommended event/performance support service vendors or artists including those so selected is generated, and transmitted to terminals 130a of the event/performance organizers S440.

The terminals 130a of the event/performance organizers select, via a dedicated application for event/performance support service, at least one vendor or artist from the list of the recommended event/performance support service vendors or artists, and transmits the same to the device for providing event/performance support service 10 S445.

The device for providing event/performance support service 10 forwards service requests to the terminals of event/performance support service vendors 110a or the terminals of artists 120a S450. Herein it is preferable that the service requests to be forwarded include basic information on the event/performance the organizer desires to host.

Thereafter, the device for providing event/performance support service 10 receives replies to the service requests from the terminals of the event/performance support service vendors 110a or the terminals 120a of the artists S460. The replies to the service requests so received, that is, information on availabilities is forwarded to the terminals 130a of the event/performance organizers.

And then the device for providing event/performance support service 10 generates a specification of an event/performance including information on at least one of the event/performance support service vendors confirmed, summary of stage settings, cost estimate, names of the artists confirmed, planned contents of event/performances, and sends the same to the terminals 130a of the event/performance organizer S470. The terminals 130a of the event/performance organizers may display the specification of the event/performance so received via the dedicated application for event/performance support service.

Communication channels between the terminals of the event/performance organizers 130a and the terminals of the event/performance support service vendors confirmed 110a or the terminals of the artists confirmed 120a may be created respectively so that a peer to peer communication between them is possible S480, S485.

Herein each communication channel should be understood as including any communication system in which data can be directly transmitted or received not by sharing the devices for providing event/performance support service 10 but by sharing IP addresses via wired or wireless communication networks.

What is claimed is:

1. A method for providing event/performance support service comprises steps of:
inputting, by an event/performance organizer with a dedicated application for event/performance support service installed on the event/performance organizer's terminal, basic information including scale and type of an event/performance;
selecting event/performance service vendors based on the basic information so input, generating a list of recommended event/performance support service vendors including information on their service, and providing the same via the dedicated application;
selecting, via the dedicated application, at least one from the list of recommended event/performance support service vendors;
forwarding information on the event/performance organizer and their service requests to the event/performance support service vendors; and
receiving replies to the service requests from the event/performance support service vendors, and notifying the event/performance organizer of availabilities of the event/performance support service vendors.

2. The method for providing event/performance support service according to claim 1 further comprises steps of:
receiving, via the dedicated application for event/performance support service, requests for information on artists;
generating a list of recommended artists by matching information on profile and schedule of individual artists stored with service requests received, and then providing the same via the dedicated application for event/performance support service; and
selecting at least one from the list of the recommended artists so provided via the dedicated application for event/performance support service;
forwarding service requests to the artists so selected, and, once having received replies to the service requests from the artists, notifying the event/performance organizer of availabilities of the artists via the dedicated application for event/performance support service.

3. The method for providing event/performance support service according to claim 2 further comprises updating and storing schedules of the artists accordingly once replies to the service requests are received from the artists selected.

4. The method for providing event/performance support service according to claim 1 further comprises steps of:
applying at least one item of type, budget, number of audience, etc based on basic information input and then generating a list of recommended event/performance models as matching given conditions selected from those preplanned and stored as a form of package in the database;
selecting at least one from the list of the recommended event/performance models provided via the dedicated application for event/performance support service; and
forwarding service requests to planners of event/performance models so selected, and notifying availabilities to the event/performance organizer once replies to the service requests are received.

5. The method for providing event/performance support service according to claim 4 further comprises selecting at least one of specific options for the event/performance model so selected such as MCs, type of choreography, chorus, stage settings, and sound effect, etc.

6. The method for providing event/performance support service according to claim 1 or 2 further comprises generating a specification of an event/performance including information on at least one of the event/performance support service vendors confirmed, summary of stage settings, cost estimate, names of the artists confirmed, planned contents of event/performance and then providing the same via the dedicated application for event/performance support service.

7. A device for providing event/performance support service comprises:
a service request input module for inputting, by an event/performance organizer via a dedicated application for event/performance support service installed on the event/performance organizer's terminal, basic information including scale and type of an event/performance;
a support service list module for selecting event/performance service vendors based on the basic information so input, generating a list of recommended event/performance support service vendors including information on their service, and providing the same via the dedicated application;
a selection module for selecting, via the dedicated application, at least one from the list of recommended event/performance support service vendors;
a service request forwarding module for forwarding information on the event/performance organizer and their service requests to the event/performance support service vendors; and
a notification module for receiving replies to the service requests from the event/performance support service vendors, and notifying the event/performance organizer of availabilities of the event/performance support service vendors.

8. The device for providing event/performance support service according to claim 7 is characterized in that:
the service information list module further receives, via the dedicated application for event/performance support service, requests for information on artists;
the support service list module generates a list of recommended artists by matching information on profile and schedule of individual artists stored with service requests received, and then provides the same via the dedicated application for event/performance support service;
the selection module selects at least one from the list of the recommended artists so provided via the dedicated application for event/performance support service; and
the notification module forwards service requests to the artists so selected, and, once having received replies to the service requests from the artists, notifies the event/performance organizer of availabilities of the artists via the dedicated application for event/performance support service.

9. The device for providing event/performance support service according to claim 7 is characterized in that:
the support service list module applies at least one item of type, budget, number of audience, etc. of event/performances based on basic information input and then generates a list of recommended event/performance models as matching given conditions selected from those preplanned and stored as a form of package in the database;
the selection module selects at least one from the list of the recommended event/performance models provided via the dedicated application for event/performance support service; and
the notification module notifies availabilities to the event/performance organizer once replies to the service requests are received.
